(19) United States
(12) Patent Application Publication
(10) Pub. No.: US 2009/0109808 A1
(43) Pub. Date: Apr. 30, 2009

(54) OPTICAL HEAD DEVICE AND INFORMATION

(75) Inventors: Nobuaki Kaji, Yokohama-shi (JP); Kazuo Watabe, Yokohama-shi (JP); Takashi Usui, Yokohama-shi (JP); Keiichiro Yasu, Yokohama-shi (JP); Chosaku Noda, Yokohama-shi (JP); Kazuto Kuroda, Yokohama-shi (JP); Masahiro Saito, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/208,658

(22) Filed: Sep. 11, 2008

(30) Foreign Application Priority Data
Oct. 25, 2007 (JP) 2007-278108

(51) Int. Cl. G11B 7/00

(52) U.S. Cl. 369/44.23; G9B/7

(57) ABSTRACT

According to one embodiment, a laser drive circuit which supplies a drive current to a laser element which outputs light at a predetermined wavelength, and a laser control circuit which supplies a predetermined timing pulse for generation of relaxation oscillation in a laser drive current supplied to the laser drive circuit, the laser control circuit supplying a laser drive current higher than a threshold value which is supplied from the laser drive circuit to the laser element to enable laser light to be output from the laser element, the laser control circuit setting the laser drive current to a level lower than the threshold value on the basis of the timing pulse.

### CROSS-REFERENCE TO RELATED APPLICATIONS

This application is based upon and claims the benefit of priority from Japanese Patent Application No. 2007-278108, filed Oct. 25, 2007, the entire contents of which are incorporated herein by reference.

### BACKGROUND

1. Field

One embodiment of the invention relates to an information recording/reproducing apparatus for recording information on a recording medium using sub-nanosecond class pulse laser light, and it also relates to an optical head device for use in such apparatus.

2. Description of the Related Art

Optical discs are widely used as recording media suitable for the recording, reproduction and erasure (rerecording) of information. It is to be noted that optical discs are classified into a CD standard and a digital versatile disc (DVD) standard by recording capacity. Especially for the recording of images and sound (music data), HD DVDs and Blu-ray discs (BD), which are developments of the DVD standard, are widely used as well as the DVD standard for their recording capacities.

As a method of recording on the optical discs mentioned above, there has been developed a method of recording information at higher density using a sharp recording pulse of a length smaller than 1 nanosecond (ns). This recording method is called, for example, a sub-nanosecond pulse recording method, or a recording method using relaxation oscillation (relaxation oscillation).

Japanese Patent Application Publication (KOKAI) No. 2002-123963 has disclosed an optical disc recording apparatus/laser diode drive method using relaxation oscillation. In addition, according to the description in this publication, a current injected to a laser diode element is decreased when laser light for recording is output, and the period of the decrease is 2 GHz to 4 GHz.

However, the recording apparatus/laser diode drive method described in the above-mentioned publication only relates to the use of relaxation oscillation to improve rising and falling characteristics of the laser light for recording, and mentions neither the stabilization of a recording pulse length nor the use of a sharp pulse generated by the relaxation oscillation for the recording of information.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information reproducing apparatus (an optical disc apparatus) according to an embodiment of the invention;

FIG. 2 is an exemplary diagram showing an example of a pickup head (PUH) using the optical disc apparatus shown in FIG. 1, according to an embodiment of the invention;

FIG. 3 is an exemplary diagram showing an example of a resonator length of a laser element (a laser unit) using the PUH of the optical disc apparatus shown in FIG. 2, according to an embodiment of the invention;

FIGS. 4A to 4D are exemplary diagrams each showing an example of the relation between light emission of the laser element and a laser drive current in the PUH of the optical disc apparatus shown in FIG. 2, according to an embodiment of the invention;

FIG. 5 is an exemplary diagram showing an example of an output waveform of laser light output from the laser element in the PUH of the optical disc apparatus shown in FIG. 2, according to an embodiment of the invention;

FIG. 6 is an exemplary diagram showing an example of the relation among a drive current supplied to the laser element, a laser output waveform, and (the formation process of) a recording mark formed in a recording film in the PUH of the optical disc apparatus shown in FIG. 2, according to an embodiment of the invention;

FIG. 7 is an exemplary diagram showing an example of the relation between the laser output waveform and a “T1” period in the PUH of the optical disc apparatus shown in FIG. 6, according to an embodiment of the invention;

FIG. 8 is an exemplary diagram showing an example of the waveform of a relaxation oscillation pulse when the resonator length of the laser element is 800 μm in the PUH of the optical disc apparatus shown in FIG. 2, according to an embodiment of the invention;

FIG. 9 is an exemplary diagram showing an example of a laser oscillation condition in which the laser output waveform shown in FIG. 8 is obtained in the PUH of the optical disc apparatus shown in FIG. 2, according to an embodiment of the invention; and

FIG. 10 is an exemplary diagram showing an example of the relation between data (NRZI) recorded using sub-nanosecond pulse recording of the present embodiment and a corresponding drive current waveform of the laser element, in an information reproducing apparatus (an optical disc apparatus) according to an embodiment of the invention.

### DETAILED DESCRIPTION

Various embodiments according to the invention will be described hereinafter with reference to the accompanying drawings. In general, according to one embodiment of the invention, an optical head device comprising: a laser element which outputs light at a predetermined wavelength; a laser drive circuit which supplies a drive current to the laser element; and a laser control circuit which supplies a predetermined timing pulse for generation of relaxation oscillation in a laser drive current supplied to the laser drive circuit, the laser control circuit supplying a laser drive current higher than a minimum current value (threshold value) of the laser drive current enabling laser light to be output from the laser element, the laser control circuit setting the laser drive current to a level lower than the threshold value on the basis of the timing pulse.

Embodiments of this invention will be described in detail with reference to the drawings.

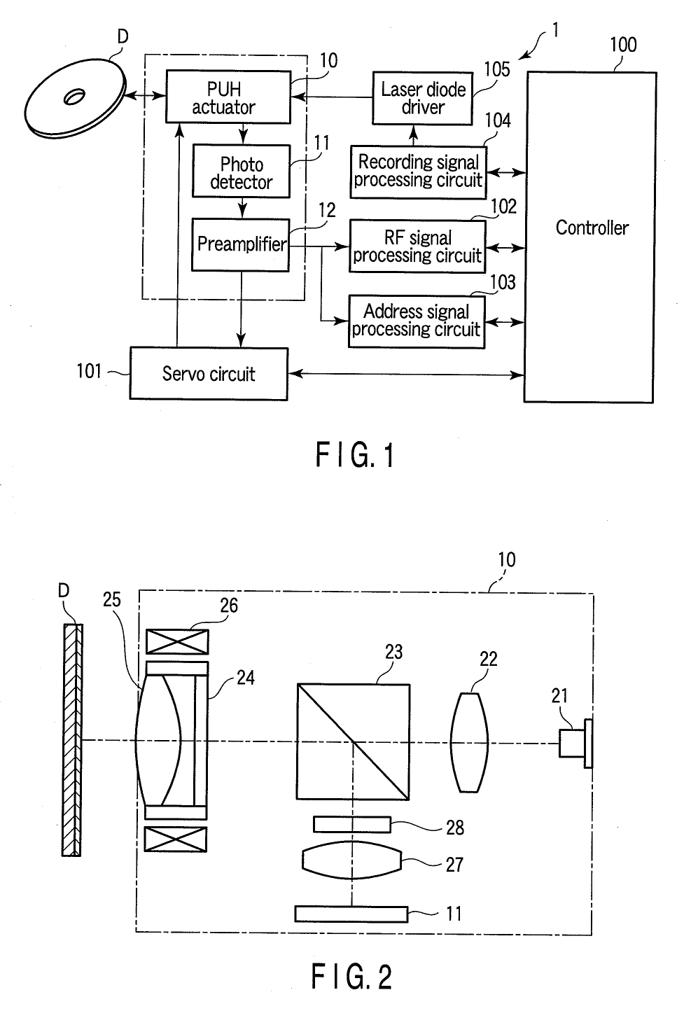

FIG. 1 shows one example of the configuration of an information recording/reproducing apparatus (optical disc apparatus) to which the embodiment of the present invention is applicable.

The information recording/reproducing apparatus shown in FIG. 1, that is, an optical disc apparatus 1, collects laser light emitted from an optical pickup (PUH actuator) 10 onto an information recording layer of a recording medium, that is, an optical disc D, thereby enabling information to be recorded on or reproduced from the optical disc D.

The optical disc D is supported on an unshown turntable of an unshown disc motor, and rotated at a predetermined velocity when the disc motor is rotated at a predetermined rotation number.

The PUH (optical pickup) 10 is moved at a predetermined velocity in the diametrical direction of the optical disc D by an unshown pickup feed motor during the operation of recording, reproducing or erasing information.

As described below with FIG. 2, the PUH 10 contains: a laser diode (LD) 21 for outputting laser light (light beam) at a predetermined wavelength, for example, a wavelength of 405 nm; and an objective lens 25 for collecting the light beam output from the laser diode (LD) 21 onto a recording surface of the optical disc D and for picking up a reflection light beam reflected from the recording surface (signal surface) of the optical disc D.

Also incorporated in the PUH 10 are: a photodetector (PD) 11 for receiving the reflection light beam generated by the reflection of the light beam which has been output from the LD 21 on the recording surface of the optical disc D and for outputting a current or voltage corresponding to the strength of the reflection light beam; an unshown focus control coil for moving the objective lens 25 in a direction perpendicular to the surface of the optical disc D; a tracking control coil 26 for moving the objective lens 25 in the diametrical direction of the optical disc D; etc.

A signal detected by the photodetector 11 is processed in a subsequently provided signal processing unit so that it can be used for a data signal for reproducing information. Further, the output from the photodetector 11 is processed so that it can be used for control signals for locating an objective lens 22 (PUH 10) at a predetermined position in relation to the recording surface of the optical disc D, that is, a focus error signal used to supply a focus control coil with a focus control signal and a track error signal used to supply a tracking control coil 26 with a tracking control signal.

In addition, as the optical disc D from which the optical pickup (PUH) 10 of the present invention can read at least the reflection light beam for tracking control, it is possible to use, for example, a (next-generation) DVD (hereinafter referred to as an “HD DVD”) standard optical disc which is a new standard and which is capable of recording at a higher density than the current DVD standard optical discs. Needless to say, it is also possible to use various kinds of known discs such as a DVD-RAM disc and a DVD-RW disc capable of recording and erasing information by the current DVD standard, a DVD-R disc capable of new information recording, and a DVD-ROM disc on which information is already recorded.

The laser light reflected from the optical disc D is detected as an electric signal in the photodetector (PD) 11 of the PUH 10. An output signal of the PD 11 is amplified in a preamplifier 12, and output to a servo circuit (lens position controller) 101, an RF signal processing circuit (output signal processing circuit) 102 and an address signal processing circuit 103 which are connected to a controller (lens position controlled variable setting unit (main control unit)) 100.

The servo circuit 101 generates a focus servo (control of the difference of the distances from the focal position of the objective lens between the recording layer of the optical disc D and the objective lens) signal of the objective lens 22 supported on the PUH 10, and a tracking servo (control of the position of the objective lens in a direction traversing the track of the optical disc D) signal. These signals are output to focus actuator (not shown) and tracking actuator (not shown) called lens position controlling mechanisms of the PUH 10, respectively.

The RF signal processing circuit 102 extracts user data and management information from the signal which has been detected by the PD 11 and reproduced, and the address signal processing circuit 103 extracts address information, that is, information indicating a track or sector of the optical disc D which the objective lens of the PUH 10 is currently facing. Such information is output to the controller 100.

The position of the PUH 10 is controlled by the controller 100 on the basis of the address information in order to read data such as user data at a desired position or to record user data or management information at a desired position.

Furthermore, the controller 100 instructs on the strength of the laser light output from a laser element (LD) in the recording or reproduction of information. In addition, the instruction of the controller 100 enables the erasure of data already recorded in an address (track or sector) at a desired position.

During the recording of information on the optical disc, a recording signal processing circuit 104 supplies a laser drive circuit (LDD) 105 with recording data which has been modulated into a recording waveform signal suitable for recording on the optical disc, that is, with a recording signal (under the control of the controller 100). Laser light whose strength has been changed in accordance with information to be recorded is output from the laser element of the PUH 10 in response to a laser drive signal supplied from the LDD 105. In this manner, information is recorded on the optical disc D.

FIG. 2 shows one example of the optical pickup (PUH) of the optical disc apparatus shown in FIG. 1.

The PUH 10 includes an LD which is, for example, a laser diode element, that is, a light source 21. The wavelength of the laser light output from the LD 21 is, for example, 405 nm.

The laser light from the LD (light source) 21 is collimated by a collimator lens 22, and passed through a polarizing beam splitter (PBS) 23 and a quarter wave plate (polarization control element) 24 that have been arranged in advance at predetermined positions, and then acquired by the collecting element, that is, the objective lens (OL) 25. The laser light acquired by the objective lens 25 is given predetermined convergence properties by the objective lens 25 (the laser light from the LD 21 is guided by the objective lens 25 and presents a minimum light spot at the focal position of the objective lens 25). In addition, the objective lens 25 is made of, for example, plastic, and has a numerical aperture NA of, for example, 0.65.

The laser light reflected by the information recording surface of the optical disc D is picked up by the objective lens 25, given a substantially parallel sectional beam shape, and returned to the polarizing beam splitter 23. In addition, in reflection laser light reflected from the optical disc D, the direction of the polarization of the laser light toward the optical disc D is changed 90 degrees by the quarter wave plate 24.

As the direction of the polarization has been rotated 90 degrees by the quarter wave plate 24, the reflection laser light returned to the polarizing beam splitter 23 is reflected by the polarizing beam splitter 23, and imaged on a light receiving surface of the photodetector 11 by a focus lens 27. Further, the reflection laser light is passed through a light splitting element 28 at a stage before predetermined convergence properties are given by the focus lens 27, such that the reflection laser light is split into a predetermined number of fluxes in accordance with the arrangement of detection regions previously provided in the photodetector (PD) 11.

More specifically, the laser light generated from the laser diode (LD) 21 is collimated by the collimator lens 22. This laser light is linearly polarized light, and it penetrates the polarizing beam splitter (PBS) 23, has its polarization plane changed (rotated) into circularly polarized light by the quarter wave plate 24, and is collected onto the optical disc D by the objective lens 25.

The laser light collected onto the optical disc D is modulated by a recording mark (recording mark array) recorded in the optical disc, a groove, etc.

The reflection laser light reflected or diffracted by the recording surface of the optical disc D is again substantially collimated by the objective lens 25, again passed through the quarter wave plate 24, and has the direction of polarization changed 90 degrees from its approach route.

Thus, the reflection laser light of which the direction of polarization has been changed 90 degrees from the approach route is reflected by the polarization plane of the polarizing beam splitter (PBS) 23, and passed through the light splitting element 28, such that the reflection laser light is split into a plurality of light fluxes corresponding to the detection regions previously provided in the photodetector (PD) 11, and deflected in a predetermined direction (for each of the split laser lights, the distance from the center to a light receiving region of the photodetector provided for each laser light is changed).

Subsequently, the reflection laser light split into the predetermined number of fluxes is collected to the predetermined light receiving regions of the photodetector 11 by the lens 27.

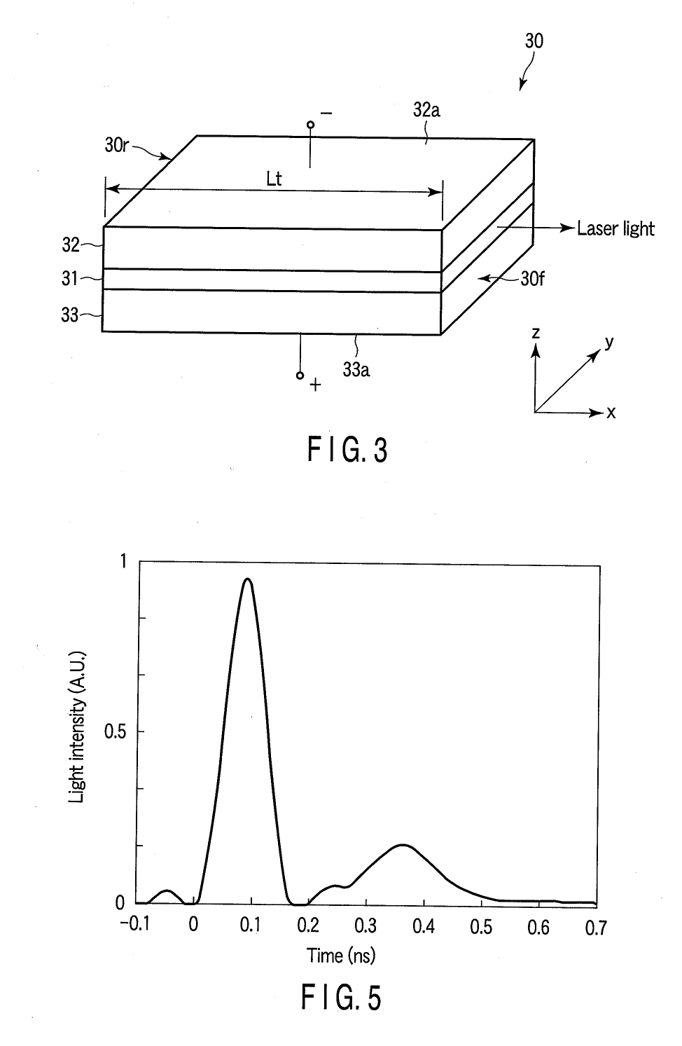

FIG. 3 is a schematic diagram explaining the configuration (resonator length) of the laser diode.

The laser diode (LD) 21 includes a laser diode chip 30 as schematically shown in FIG. 3 in a housing (not shown).

The laser chip 30 is a small block having, for example, a thickness (vertical direction) t of about 0.15 mm, a length (horizontal direction) L of about 0.5 mm, and a breadth (depth direction) d of about 0.2 mm.

The laser chip 30 includes an active layer 31 vertically interposed between first and second claddings 32, 33, and an upper end 32a of one cladding and a lower end 33a of the other cladding serve as a “−(minus)” electrode (32a) and a “+(plus) electrode (33a)”, respectively.

The materials of the first and second cladding layers 32, 33 are selected so that their refractive indices are, for example, about 5% lower than the refractive index of the active layer 31. Light generated in the active layer 31 proceeds in the active layer 31 while being reflected at the boundary between the upper and lower cladding layers, is gradually amplified during movement between mirror surfaces 30f, 30r, and released as laser light from the mirror surfaces 30f, 30r when amplified to a predetermined level. That is, the laser light is output in an x direction parallel with the direction in which the active layer 31 extends, in the example in FIG. 3. In addition, the distance between the first and second mirror surfaces 30f, 30r is a resonator length Lt.

In the laser chip 30 shown in FIG. 3, the distance L between the first and second mirror surfaces 30f, 30r is determined depending on a required pulse length of the laser light, and the resonator length Lt is about 0.8 mm in this example. In addition, the period of relaxation oscillation, described later, is about 100 picoseconds (ps) in full width at half maximum.

A drive current is supplied to the LD 21 from the laser drive circuit (LDD) 105 shown in FIG. 1, such that the LD 21 emits (oscillates) laser light. In addition, the rising time of the drive current supplied from the LDD 105 to the LD 21 is about 1 nanosecond (ns).

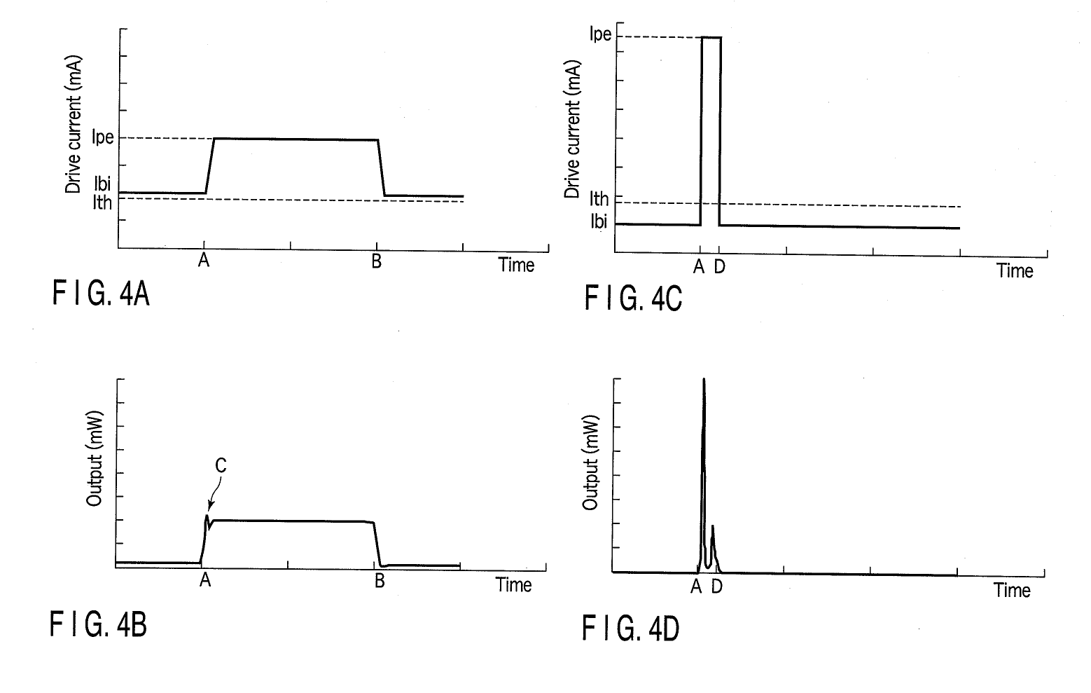

Next described with reference to FIGS. 4A to 4D will be a method of generating a recording pulse (laser drive method) which can be used to record information in an unshown recording film of the recording medium, that is, the optical disc D.

FIGS. 4A and 4B show the relation between a general laser drive current and the emission (laser output) of the laser light when the laser drive current is supplied, in the laser diode element. FIG. 4C shows an example of the supply of a laser drive current which can obtain a relaxation oscillation pulse (characteristic laser output), and FIG. 4D shows a laser output when such a laser current is driven.

As shown in FIGS. 4A and 4C, the drive current is controlled at two levels: a bias current Ibi and a peak current Ipe. In addition, the bias current may be further divided and controlled at two or three levels in some cases, but for simplification of explanation, the bias current and the peak current each have one level in the case described here.

When a normal recording pulse is generated, the LDD 105 first generates the bias current Ibi set at a level slightly higher than a threshold current Ith at which the LD 21 starts laser oscillation, and preliminarily drives the LD 21, as shown in FIG. 4A. Then, until the level is dropped down to the bias current Ibi at time B, the peak current Ipe for obtaining the desired peak power is applied at time A. In this manner, the peak current Ipe is applied between time A and time B, such that the laser output (a change in the strength of laser emission light with time) as shown in FIG. 4B is obtained.

That is, until the time A at which the intensity of the laser drive current is the bias current Ibi, the strength of the emitted light has a significantly low power which does not enable the laser light output from the LD 21 to record data on the optical disc D, but the peak current Ipe is applied so that the strength of the laser light increases to the recording power. It is understood that the strength of the emitted light is again at low power at and after the time B.

If the strength of the emitted light is observed in more detail, it is seen in FIG. 4B that when the strength is increased to the recording power at the time A, the strength instantaneously increases and then decreases before it stabilizes at a steady recording power (an arrow c portion in FIG. 4B). This is attributed to the relaxation oscillation of the LD 21, and the relaxation oscillation is controlled to the minimum in normal recording pulse generation.

The relaxation oscillation is a relaxation oscillation phenomenon which occurs when the drive current rapidly increases from a certain level to a fixed level far exceeding the threshold current in the laser diode as described above.

In addition, the relaxation oscillation decreases every time the oscillation is repeated, and eventually settles down.

In the optical recording apparatus of the present invention, the relaxation oscillation is actively utilized for recording.

That is, although the generation of the relaxation oscillation should originally be inhibited, the present invention intends to “stably” obtain a sharp recording pulse having a short length by use of the characteristics of the relaxation oscillation: “a short pulse length” and “an energy amount (an integral value of laser power as an optical output) which may be able to change the recording film of the optical disc D to a recording level”.

As shown in FIG. 4C, when a drive current with a predetermined characteristic is supplied to the LD 21 from the LDD 105, oscillation is involved as seen in FIG. 4D, but a laser output with a high peak level is obtained for a slight period of time.

More specifically, the bias current Ibi set at a level lower than the threshold current Ith is supplied to the LD 21. Further, with a predetermined timing, that is, at the time A, the drive current is rapidly raised to the peak current level Ipe, which is higher than the threshold current Ith, at a rising time earlier than in the normal recording pulse generation. Then, the drive current is returned to the bias current Ibi at time D after the passage of a nanosecond-level slight moment shorter than in the normal recording pulse generation.

In this case, a laser output (a change in the strength of laser emission light with time) is obtained, as shown in FIG. 4D.

That is, in FIG. 4D, the LD 21 has not started the laser oscillation until the time A at which driving is carried out by the bias current Ibi, which is lower than the threshold current Ith, but this is a negligible level, and there is only light emission of a light emitting diode. Then, a current is rapidly applied at the time A, such that the relaxation oscillation is caused and the strength of the emitted light rapidly increases.

Subsequently, the amplitude of the relaxation oscillation gradually converges into a steady level, but a predetermined time, that is on time C, and then the drive current is set to the Ibi, which is lower than the threshold current Ith, such that laser light having a certain energy amount is obtained. In addition, as apparent from FIG. 4C and FIG. 4D, the time C is determined to be a timing whereby a second period pulse of the relaxation oscillation is generated.

Thus, the pulse generated by the relaxation oscillation is characterized in that the strength of the emitted light increases in a much shorter time than in the normal recoding pulse and that the strength of the emitted light decreases at a certain period which is determined by the structure of the laser diode. Therefore, the use of the pulse generated by the relaxation oscillation for the recording pulse makes it possible to obtain a short pulse having short rising and falling times and having a high peak strength which cannot be obtained by the normal recoding pulse.

Meanwhile, it is known that the period of the relaxation oscillation is associated with the resonator length of the laser chip of the laser diode element (LD) described with FIG. 3.

As a relation known in general, the following relation exists between the resonator length L of the LD and a relaxation oscillation period T:

T=k×{2nL/c} (1)

where k is a constant, n is the refractive index of the active layer of the laser diode, and c is the velocity of light (3.0×10⁸(m/s)).

Therefore, the resonator length of the laser chip is in proportion to the relaxation oscillation period and thus to the width of a sharp pulse generated by the relaxation oscillation. The resonator length may be increased when the pulse width of the relaxation oscillation should be increased, while the resonator length may be decreased when the pulse width of the relaxation oscillation should be decreased.

Simply described below is a method of controlling the resonator length of the laser chip to set an arbitrary width of the relaxation oscillation pulse generated by the relaxation oscillation.

FIG. 5 shows a measurement of a relaxation oscillation waveform produced by laser diode having a resonator length of 650 μm.

It is understood that a relaxation oscillation pulse width (FWHM) Wr is about 81 picoseconds (ps) in full width at half maximum.

Since the resonator length of the laser chip 30 of the LD 21 is in proportion to the relaxation oscillation pulse width as described above, the following relation is obtained as a conversion equation for the resonator length Lt of the laser chip 30 and the obtained relaxation oscillation pulse width (FWHM) Wr:

Wr(ps)=L(μm)/8.0(μm/ps) (2).

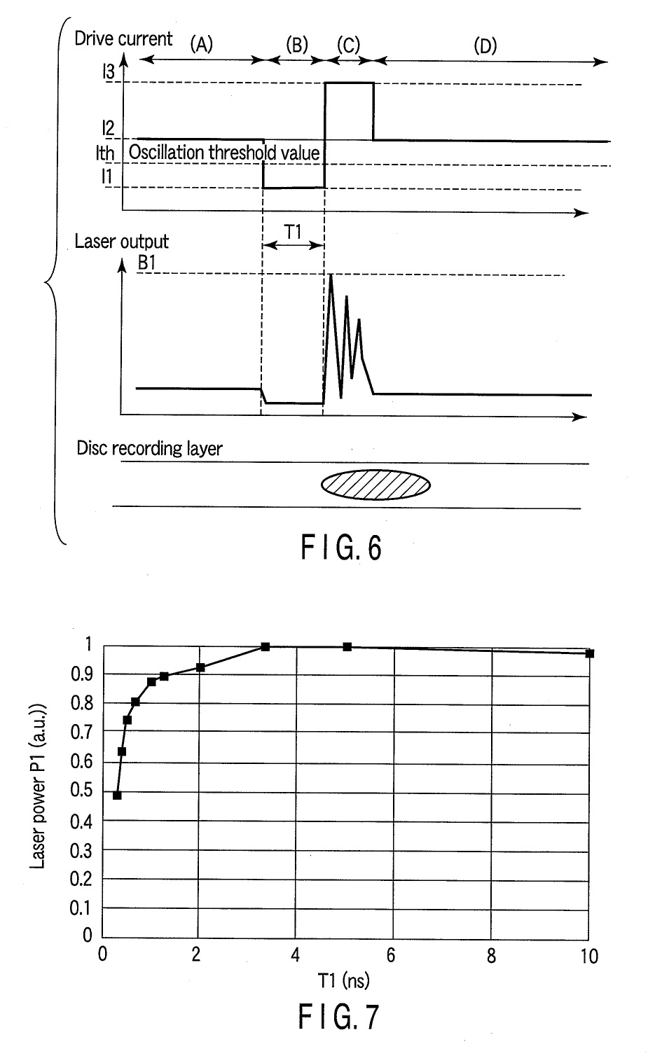

FIG. 6 shows the temporal development of the laser drive current supplied from the laser drive circuit (LDD) to the laser element (LD) in (a) of FIG. 6, the waveform of laser emitted from the LD in (b) of FIG. 6, and the shape of a mark (recording mark) formed in the recording film of the optical disc D in accordance with the output laser waveform in (c) of FIG. 6.

In (a) of FIG. 6, in a section of a region (A) where the collection point of the laser light on the recording film of the optical disc D is located at a position at which no recording mark is to be formed, the power of the laser light emitted from the LD 21 is controlled to a reproduction power used for reproducing information from the optical disc D in order to read information on the position on the optical disc D and to place servo in operation. That is, the LD 21 is supplied with a drive current of intensity I2, which is higher than the Ith, the threshold value of the drive current which can oscillate the laser.

Furthermore, in a section (C), the LD 21 is supplied with a laser drive current of I3, which is higher than I2, and a relaxation oscillation pulse laser light whose maximum value reaches P1, see (b) of FIG. 6, is output.

In addition, during the predetermined time T1 immediately before the region (C) where the relaxation oscillation pulse light is output, that is, in the region (B), the LD 21 is supplied with the laser drive current of intensity I1, which is lower than the threshold value Ith.

Moreover, the intensity of the laser drive current after the end of the relaxation oscillation, that is, in a region (D) is again the above-mentioned I2, which is higher than the threshold value Ith.

That is, in the present invention which records information on the optical disc D using the sharp pulse laser obtained by the relaxation oscillation, the time-average power of the laser light applied during recording is smaller than the laser power (production power) necessary to reproduce information recorded in the optical disc D, and the average laser power emitted from the laser is varied when recording is started immediately after information is reproduced from the optical disc D.

Due to the variation of the average laser power, the temperature of the LD 21 changes, and the threshold current of the LD 21 also varies.

The variation of the threshold value changes the laser strength before and after the temperature change even when the LD 21 is driven by the same current. It is therefore desirable that such a change of the threshold value be not made in order to record a satisfactory mark in the recording film of the optical disc D.

To avoid such a problem, it is desirable for the average power of the laser in reproduction to be substantially equal to the average power of the laser in recording. In addition, regarding the average powers of the laser in reproduction and recording, it has been found out that, for example, a first average power (A) used for reproduction and a second average power (B) used for recording are at such degrees that can substantially neglect the effects of the temperature change in the following range:

0.8<A/B<1.2.

FIG. 7 shows the relation between the time T1 for setting the current value supplied to LD (laser element) to I1 and maximum strength P1 of the relaxation oscillation during the drive time. The LD has a wavelength of 405 nm, a resonator length of 800 μm, and a laser oscillation threshold value of 35 mA. A drive current is rapidly passed in a rising time of 150 ps from 20 mA to 120 mA.

As has already been explained, the relaxation oscillation is an oscillation phenomenon which occurs when the drive current rapidly increases from a certain level to a fixed level far exceeding the threshold current in the laser diode (an oscillation system), so that the pulse width (recording pulse length) is required to be stable in order to use the relaxation oscillation as a recording pulse. In addition, it has been found out that the maximum power P1 of the laser generated by the relaxation oscillation is low when the time T1 is short and that P1 increases up to about 2.2 times as great as the steady oscillation power as T1 increases. Moreover, although P1 converges later, the laser strength after the convergence of the relaxation oscillation is 0.45×P1 in the present embodiment.

It has been known that the total recording energy is smaller when the peak power P1 at the head of the relaxation oscillation is great than in the case of recording by steady power oscillation. The reason is that the thermal diffusion time is about 1 ns in an optical disc in which the recording mark is recorded by thermal recording (an amount of heat energy supplied as laser light) as compared with the case where the mark is recorded by the applying laser for a long time with normal low power, so that heat is also diffused during the application of the laser in the case of a normal recording waveform, whereby recording is carried out for a longer time. In contrast, in the case of the relaxation oscillation, a high power is emitted for a short time of 1 ns or less, so that the thermal diffusion is less during the time of laser application. Thus, the recording energy in which power is integrated by time is smaller in the recording method using the relaxation oscillation than in the normal recording method exceeding 1 ns. When the peak power P1 at the head of the relaxation oscillation is 2.2 times as great as the normal steady laser strength as described above, the recording energy decreases to about 40% of that of the normal steady oscillation laser. This reduces the energy consumption of the pickup head, so that the temperature rise of the pickup head is inhibited. Optical elements of the pickup head such as the objective lenses and mirrors thermally expand and deform due to the temperature rise, so that the diameter of a spot where light is collected by the objective lens increases, and the size of the mark to be recorded increases. However, if recording is carried out using the relaxation oscillation, the temperature rise can be inhibited, and such a problem can thus be lessened.

In particular, the effect of decreasing the recording energy is obvious when P1 is double or more that of the steady laser as compared with the above-mentioned application of the normal steady laser. It is therefore understood that when the mark is recorded using the relaxation oscillation, the period of T1 in which P1 has a value of 90% of the value of saturation is desirably 1 ns or more.

Furthermore, it has been proved that the power is equal to the saturation power if T1 is 3 ns or more and that there is almost no effect on the laser output during the period of T1 with higher power. It is therefore more desirable that T1 is 3 ns or more.

On the other hand, a rising time Tr and falling time Tf of the current emitted from the LDD 105 to the LD 21 (these are times required for a variation from 10% to 90% of the maximum current running in the LD 21) are both 150 ps in consideration of all of the electric capacities and induction coefficients of the LD 21, the LDD 105 and unshown wiring lines extending from the LDD 105 to the LD 21.

In addition, when the rising time is long, a longer time is taken from the point where a current value equal to or less than the threshold value is set in the LDD 105 to the point where the value of the current actually running in the LD 21 becomes equal to or less than the threshold value. This time is substantially equal to the falling time Tf, so that preparing T at an interval of Tf+0.85 ns or more is useful in order to generate relaxation oscillation of a suitable intensity. That is, if Tf is 150 ps, T1 is preferably 1000 ps or more.

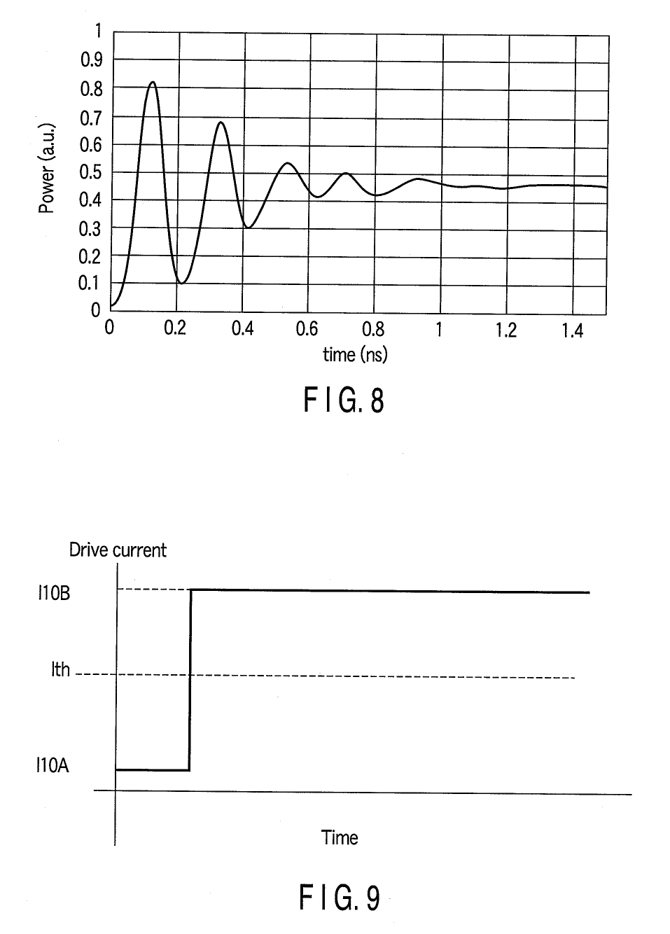

FIG. 8 shows the waveform of the laser output from the LD when a drive current as shown in FIG. 9 is applied to the LD. That is, a current is passed in the following manner: A current I10B, which is higher than the threshold value, is rapidly passed to the LD after a current I10A which is lower than the laser oscillation threshold value, and this current is maintain so far. In this case, the laser waveform as shown in FIG. 8 is obtained. That is, the relaxation oscillation is generated four or five times during a certain period of time, and then laser oscillation of a steady output follows.

As shown in FIG. 8, when the resonator length of the laser chip 30 of the LD 21 is 800 μm, time for convergence to 0.45×P1 is about 1 ns (1.5 ns even when the range in FIG. 8 is defined as the relaxation oscillation) if the peak power P1 is “1”. In addition, the number of times that the relaxation oscillation is generated until it reaches convergence does not depend on the resonator length of the LD. On the other hand, since the period of the relaxation oscillation is in proportion to the resonator length as described above, the time for the convergence of the relaxation oscillation in relation to the resonator length Lt (μm) is Lt/800 (ns). In the case of recording, using the relaxation oscillation, the quality of the marks drop when a steady power laser output without relaxation oscillation is long. Thus, a temperature rise in the recording layer of the optical disc when the laser in a state of relaxation oscillation is applied is higher than a temperature rise when the laser in a steady state is applied. Consequently, the width of a mark recorded when the laser is in the relaxation oscillation state is greater than the width of a mark recorded when the laser is in the steady state. This leads to a nonuniform width of the mark and a decreased quality level of the mark. Therefore, in order to prevent such a problem, it is desirable for the recording pulse width to be smaller than the time for the relaxation oscillation to shift to the steady state.

Thus, when the resonator length is 800 μm, the recording pulse length, that is, the length of the section (C) in FIG. 6 has only to be shorter than 1500 ps (1.5 ns).

As described above, in the recording using the relaxation oscillation, the width of the sharp recording laser pulse induced by the relaxation oscillation is 1.5 ns or less which is shorter than the laser output produced by the supply of a general drive current, such that laser light with a high peak output P1 is emitted.

Consequently, in the optical disc in which the recording mark is recorded by thermal recording (the amount of heat energy supplied as laser light), the recording energy can be smaller in the recording method using the relaxation oscillation than in the case where the mark is recorded by the applying the laser for a long time with normal low power.

That is, the use of the recording pulse obtained by the relaxation oscillation allows a shorter time for the application of the laser light to the recording film of the optical disc D than in the case of using laser light without relaxation oscillation, thereby reducing the amount of heat diffused from the place in the recording layer of the optical disc where the laser is applied to other places.

This also shows that average laser power required as the recording pulse can be smaller than in the conventional recording methods.

In addition, in the “sub-nanosecond pulse recording” described with FIGS. 1 to 3, 4A, 4B, 4C, 4D and 5 to 9, pulsed emissions of laser are performed in which the emission time of the laser is less than 10% (1% to 10%) of a mark length which is one of the recording mark unit, i.e., “a length of one of the recording marks” to be recorded on the optical disc (information recording medium), so that the average value of the power during the recording of the laser light may be less than that of the power for reproduction.

On the other hand, the difference of reflectance between a mark portion and a space portion may be small, depending on the material of the optical disc as a recording medium. Therefore, there has been developed a recording medium in which the reflectance of the mark portion or the space portion is decreased to about 2% when information is recorded in order to improve the apparent contrast.

When the recording method based on the sub-nanosecond pulse is applied to the recording of information on such a recording medium, an average amount of light returning to the photodetector in the optical head during recording is significantly small. Thus, the quality level of a detected signal is significantly deteriorated, and it may be impossible to perform the operation (focus/tracking servo) of obtaining an error signal from the detected signal to fix the objective lens at a predetermined position in the recording layer.

Thus, the inventor has proposed the optical disc apparatus shown in FIG. 1 as an information recording/reproducing apparatus which increases the average amount of light by the superposition of a high-frequency signal between recording pulses to perform recording based on the sub-nanosecond pulse and which can also normally operate the focus/tracking servo.

However, in the case of generating a recording pulse using the sub-nanosecond pulse, when the high-frequency signal is superposed between the recording pulses, there is a risk that unnecessary (unintended) relaxation oscillation may be generated in the laser diode (LD) 21 if there is a great difference between the potential (or current) level of the edge of the recording pulse and the potential (or current) level of the continuous high-frequency signal. When there is unnecessary relaxation oscillation, the laser light becomes uneven, leading to a disturbed recording mark and a disturbed reproduction signal.

Thus, the high-frequency signal is superposed between the recording pulses to prevent the generation of the unnecessary relaxation oscillation.

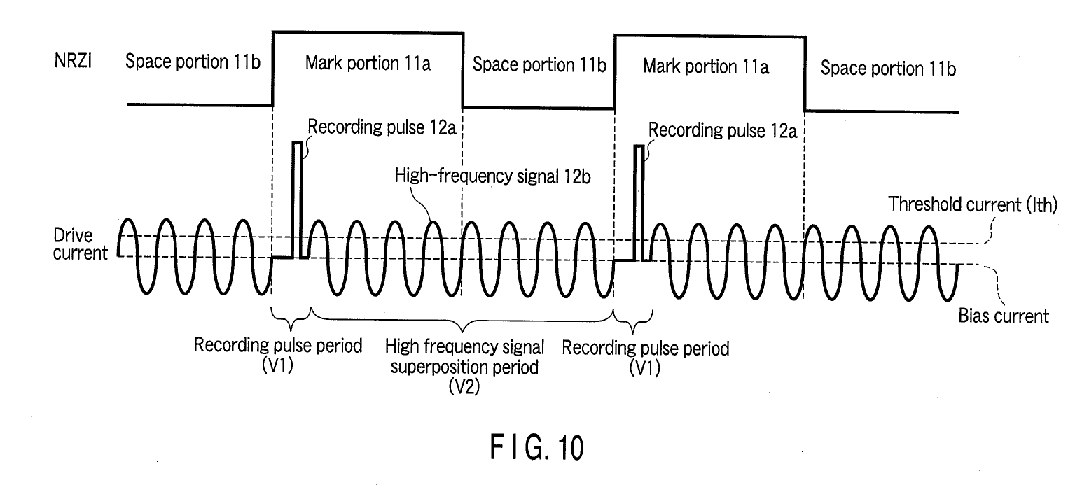

In one example of this shown in FIG. 10, when data (NRZI) to be recorded and a drive current waveform of the corresponding laser diode (LD) contain a recording pulse period (V1) and a high-frequency signal superposition period (V2), a recording pulse 12a is output one or a plurality of times in a mark portion 11a. Further, other than the recording pulse period (V1), a high-frequency signal 12b is output independently of the mark portion 11a and a space portion 11b. Thus, the average strength of the laser diode is maintained.

Owing to the drive current in the recording pulse period (V1), the LD 21 emits a stronger light in the recording pulse period (V1) than in the high-frequency signal superposition period (V2). Due to this strong light emission, the recording layer of the optical disc thermally changes, and a recording mark is formed. The drive current in the high-frequency signal superposition period (V2) has such a value that the average light strength of the laser diode does not thermally or optically change the recording layer of the optical disc.

This light strength is often the strength at which information is read from the recording layer of the optical disc. The level of the threshold current shown is a level which serves as a boundary between the start and stopping of the light emission of the laser diode. In order to obtain the relaxation oscillation, the laser diode requires a recording pulse which rapidly changes from a level equal to or less than this threshold current level. Therefore, for recording, it is necessary to once decrease the current to a current equal to or less than the threshold current from a current value for obtaining light strength to read information of the recording layer of the optical disc, and then obtain the rapidly changing recording pulse 12a. In a recording mode, the light strength for reading information from the optical disc is necessary when, for example, an address is read. In addition, a period may be provided between the recording pulse 12a and the high-frequency signal 12b so that the drive current is fixed as a bias current.

As described above, in the recording using the sub-nanosecond pulse, a state called the relaxation oscillation is created in the laser diode to obtain light with a high emission strength. Therefore, light emission is maintained with attenuating emission strength even after the drive current has been stopped from the recording pulse 12a. Stable recording is enabled by providing a bias period with a constant drive current after the recording pulse 12a until the relaxation oscillation settles down. In addition, although not shown, it is readily appreciated that a high-frequency superposition circuit may be added to the laser drive circuit (LDD) 105 shown in FIG. 1 for the recording pulse 12a so that the high-frequency signal 12b can be output.

In the above description, one kind of relation between the drive current of the laser diode and the NRZI waveform has been shown as in FIG. 10 for clarity of explanation. However, various waveforms are used as the NRZI waveform in accordance with channel data. Moreover, in accordance with this NRZI waveform, a recording pulse for effectively forming the mark portion and the space portion in the recording medium is generated.

According to one of an embodiment of this invention, the pulse width, that is, the recording pulse length of the sub-nanosecond class laser light generated together with the relaxation oscillation is stabilized. This makes it possible to improve the recording density.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head device comprising:
a laser element configured to output light at a predetermined wavelength;
a laser drive circuit configured to supply a laser drive current to the laser element; and
a recording signal processing circuit configured to supply a predetermined timing pulse to the laser drive circuit, the predetermined timing pulse is configured to cause a laser element to generate relaxation oscillation;
wherein the recording signal processing circuit is configured to cause the laser element to generate the relaxation oscillation based on the timing pulse, by setting an amount of the laser drive current smaller than a threshold amount of the laser drive current for outputting laser light from the laser element, followed by setting the amount of the laser drive current larger than the threshold amount.

2. The optical head device of claim 1, wherein duration of the relaxation oscillation generated by the timing pulse is set based on a length of a resonator of the laser element.

3. The optical head device of claim 2, wherein the duration of the relaxation oscillation generated by the timing pulse is set at 1.5 nanoseconds(ns) or shorter when the length of the resonator of the laser element is approximately 800 micrometers(μm).

4. The optical head device of claim 1, wherein duration of change in the amount of the laser drive current by the timing pulse is regulated based on the resonator length of the laser element.

5. The optical head device of claim 4, wherein the duration of change in the amount of the laser drive current by the timing pulse is regulated at 1 nanosecond or longer when the resonator length of the laser element is approximately 800 μm.

6. The optical head device of claim 1, wherein the amount of the laser drive current is substantially equal before the supply of the timing pulse and after a sustaining phase of the relaxation oscillation.

7. The optical head device of claim 6, wherein the amount of the laser drive current is configured to satisfy the following condition:
0.8<A/B<1.2
where A is the intensity of first laser light used for reproduction of information from a recording medium, and B is the intensity of second laser light used for recording of information on the recording medium.

8. An information recording/reproducing apparatus comprising:
an optical head device, the optical head device comprising
a laser element configured to output light at a predetermined wavelength,
a laser drive circuit which supplies a drive current to the laser element,
a recording signal processing circuit configured to supply a predetermined timing pulse to the laser drive circuit, the predetermined timing pulse is configured to cause a laser element to generate relaxation oscillation,
a light sending system configured to guide the light from the laser element to a recording layer of a recording medium, and
a light receiving system configured to pick up reflection light produced by the reflection of the light on the recording layer of the recording medium and to output a reproduction signal corresponding to the intensity of the reflection light;
wherein the recording signal processing circuit is configured to cause the laser element to generate the relaxation oscillation based on the timing pulse, by setting an amount of the laser drive current smaller than a threshold amount of the laser drive current for outputting the laser light from the laser element, followed by setting an amount of the laser drive current larger than the threshold amount, and an information reproducing circuit configured to reproduce information recorded on the recording medium based on the reproduction signal obtained by the light receiving system.

9. An information recording method of applying laser light whose intensity has been modulated by recording information to a recording medium to form a recording mark, the method comprising:
setting an amount of a laser drive current supplied to a laser element to a smaller amount than a threshold value enabling laser light to be output from the laser element, and causing the laser element to generate relaxation oscillation for a predetermined period before a timing of generating a recording pulse; and
setting the amount of the laser drive current to the threshold value enabling the laser light to be output from the laser element when the relaxation oscillation is sustained as the recording pulse for a predetermined period.

10. The information recording method of claim 9, wherein
the period in which the amount of the laser drive current is set smaller than the threshold value enabling the laser light to be output from the laser element before the timing of the generation of the recording pulse is 1 nanosecond or longer.

11. The information recording method of claim 9, wherein
the period in which the amount of the laser drive current while sustaining the recording pulse is set to 1.5 nanoseconds or shorter when the resonator length of the laser element is 800 μm or shorter.

12. The information recording method according to claim 9, wherein
the intensity of the laser drive current is
0.8<A/B<1.2,
where A is the intensity of first laser light used for reproduction of information from the recording medium, and B is the intensity of second laser light used for recording of information on the recording medium.
